(19) United States
(12) Patent Application Publication
(10) Pub. No.: US 2013/0309430 A1
(43) Pub. Date: Nov. 21, 2013

(54) POLYESTER CEREAL LINER WITH ZERO MIGRATION

(71) Applicants: Gordon Vincent SHARPS, North Kingstown, RI (US); Roberto SIU, Providence, RI (US); Jon Ian MONTCRIEFF, Foxborough, MA (US)

(72) Inventors: Gordon Vincent SHARPS, North Kingstown, RI (US); Roberto SIU, Providence, RI (US); Jon Ian MONTCRIEFF, Foxborough, MA (US)

(73) Assignee: TORAY PLASTICS (AMERICA), INC., N. Kingstown, RI (US)

(21) Appl. No.: 13/475,125

(22) Filed: May 18, 2012

(51) Int. Cl. B65D 25/14; B05D 1/26; B32B 27/08

(52) U.S. Cl. 428/36.6; 428/220; 427/407.1

(57) ABSTRACT

Peelable extrusion coated barrier films including a polyester containing layer, and methods of making and using peelable extrusion coated plastic films having a polyester containing layer. One embodiment is a barrier film including a base film layer including polyester, and an extrusion coated peelable heat seal layer including polyethylene.

### FIELD OF THE INVENTION

The invention relates to peelable extrusion coated plastic films including a polyester containing layer. This invention also relates to methods of making and using peelable extrusion coated plastic films having a polyester containing layer, especially as cereal liners.

### BACKGROUND OF THE INVENTION

Cereal liners are often packaged in cardboard boxes. Researchers have found that some of those cardboard boxes contain toxic chemicals coming from the recycled newspapers, used to make the cardboard boxes. The chemicals, known as mineral oils, come from the printing inks used in the newspapers.

Exposure to mineral oils has been linked to inflammation of internal organs and cancer. Scientists have found quantities of mineral oils between 10 and 100 times above the agreed limit in foods like pasta, rice and cereals sold in cartons made from recycled cardboard. In 2010, more than half the cardboard used in Europe was made from recycled materials. So-called “virgin board” from newly harvested trees is more expensive and there is not enough of it to replace recycled card completely.

Accordingly, there is a need for a flexible cereal liner that will block volatile migration of chemicals.

U.S. Pat. No. 5,985,772 describes nonwoven cellulosic fiber webs including, paperboards and corrugated paper board, etc., which contain a barrier layer that can act both as a barrier to the passage of a permeant and as a trap for contaminant materials that can arise in new materials or from the recycle of fiber in the manufacture of paperboard. The effective material which acts as a trap or barrier is a cyclodextrin compound, substantially free of an inclusion complex compound. The cyclodextrin barrier layer can be corrugated or sheet laminated with or on the cellulosic web. Alternatively, the cyclodextrin material can be included in a coating composition that is coated on the surface or both surfaces of the cellulosic web after web formation. Further, the cyclodextrin material can be included in a thermoplastic film that can be used as one layer in a bilayer or multilayer laminate containing a cellulosic web. This invention focuses on the paperboard, not on the flexible inner liner package.

U.S. Pat. No. 5,883,161 describes thermoplastic polymeric compositions used as packaging materials with moisture vapor barrier properties. The thermoplastic barrier material can take the form of a barrier coating, a flexible film, a semi-rigid or rigid sheet or a rigid structure. The thermoplastic barrier materials can also take the form of a coating manufactured from an aqueous or solvent based solution or suspension of thermoplastic film forming components containing as one component, the active moisture barrier forming materials. The thermoplastic barrier compositions of the invention can be extruded, laminated or molded into a variety of useful films, sheets, structures or shapes using conventional processing technology. Further, the monolayer, bilayer or multilayer films can be coated, printed or embossed. This patent does not teach about zero migration of mineral oils saturated hydrocarbons.

### SUMMARY OF THE INVENTION

Described are peelable extrusion coated plastic films including a polyester containing layer, and methods of making and using peelable extrusion coated plastic films having a polyester containing layer. Also described is an extrusion coated cereal liner that has an integral barrier to hydrocarbon-based volatiles. The liner not only helps to eliminate the migration of certain volatiles from recycled or printed board cartons, but also helps to retain the product flavor and aroma.

One embodiment is a barrier film including a base film layer including polyester and an extrusion coated peelable heat seal layer including polyethylene. The barrier film has a thickness of 5 microns to 250 microns. Preferably, the barrier film has a thickness of 9 microns to 50 microns.

In some embodiments, the base film layer may include 1 to 20 coextruded layers. The heat seal layer may also include 1 to 20 layers. The barrier film may further include a metalized layer, a colored layer, and/or an outer surface printable layer.

The heat seal layer may contain at least 75 wt. % polyethylene. The heat seal layer may include polyethylene with a density of 0.840-0.935 g/cm³, and a Melt Flow Rate of 0.1-10 g/10 minutes.

The base film layer may be biaxially oriented. The base film may contain at least 90 wt. % polyester, or may consist of polyester. The polyester may have an intrinsic viscosity (V) of greater than 0.50.

Another embodiment is a cereal liner formed from a barrier film, the barrier film including a base film layer including polyester; and an extrusion coated peelable heat seal layer including polyethylene. The barrier film may have a thickness of 5 microns to 250 microns.

Yet another embodiment is a method of making a barrier film including providing a base film layer including polyester, and extrusion coating a peelable heat seal layer including polyethylene onto the base film layer. The barrier film may have a total thickness of 5 microns to 250 microns.

### DETAILED DESCRIPTION OF THE INVENTION

The invention relates to peelable extrusion coated plastic films including a polyester containing layer. The polyester layer is inert, and provides excellent migration protection. An extrusion coated sealable layer is deposited on the polyester layer to impart properties to the cereal liner, such as heat seal strength and hot tack. The “hot tack property” denotes the force of thermoplastic resin films to pull each other at the optimum heat sealing temperature of the films (about 120° C. to 170° C. in the case of polyethylene films) which results from their tack forces and cohesive forces. While the heat-sealing strength of a resin film is the strength of a sealed portion measured after the heat-sealed portion has cooled to room temperature (when the resin of the film has solidified), the hot tack property denotes the heat sealing strength of a heat-sealed portion immediately after heat sealing when that portion is still close to the heat sealing temperature.

Embodiments of the films can be made from a biaxially oriented polyester film with an extruded polyolefin layer. The polyester film can be produced by melt-extruding a polyester into a film, quenching and solidifying the film by winding it round a casting drum to give an unstretched film, stretching the unstretched film one or more times to a total stretching ratio of 3 to 7 times in a longitudinal direction at a temperature of Tg to (Tg+60)° C., stretching the film to a total stretching ratio of 3 to 5 times in a transverse direction at Tg to (Tg+60)° C., heating the biaxially oriented film at (Tg+50) to (Tg+140)° C. for 1 to 100 seconds, and heating it again while it is being shrunk or extended in a transverse direction by 0 to 3%. In addition to polyester, the polyester may contain a stabilizer, colorant, antioxidant and other additive as required in such amounts that do not impair inherent performance thereof.

The polyolefin heat seal layer can include a polymer or a blend of polymers selected from a linear low-density polyethylene, high-density polyethylene, propylene-ethylene copolymers; ethylene/vinyl acetate copolymer (EVA); ethylene/methacrylate copolymer; ethylene/n-butyl acrylate; ethylene/vinyl acetate/carbon monoxide; ethylene/acrylic acid (BAA); ethylene/methacrylic acid (EMAA); ionomeric salts of ethylene/carboxylic acid copolymers such as sodium, zinc or potassium ionomers of EMAA or EAA; maleic anhydride grafted EVA; maleic anhydride grafted linear low-density polyethylene; and maleic anhydride grafted polypropylene.

The film acts as a barrier to hydrocarbon migration, especially limonene and pentadecane, when used to package certain food articles, especially cereal flakes. It was surprisingly found that a polyester base film gave zero migration results, even better than metalized polypropylene film.

In accordance with this invention, the hydrocarbon migration barrier properties of an extrusion coated plastic film having a layer including a biaxially oriented polyester are essentially zero. The sealant that is extrusion coated on the polyester base film is a peelable blend of polymeric resins that allows for easy open.

The peelable, heat sealable layer is made by using a polyethylene, a polyethylene blend or a polyethylene coextrusion, including multiple layers. The density of the polyethylene is preferably 0.840-0.935 g/cm³, more preferably 0.840-0.920 g/cm³. If the density is within this range, properties such as low seal initiation temperature, pin-hole resistance and excellent mechanical strength are improved. The peelable property of the sealant can be obtained by the addition of dissimilar agents, known by the skilled in the art, or by creating a break away layer, as known in the art.

Furthermore, the polyethylene is preferably in conformity with a melt (JIS K7210, measured values; less than 190° C., at 21. 18N.) property called melt flow rate (“MFR”). The MFR is preferably 0.1-10 g/10 minutes, more preferably 0.3-8.0 g/10, and even more preferably 0.8-7.5 g/10 min. If the MFR is within this range, the extrusion coating of a sealant layer is improved.

The coextruded multilayer sealant can include a plurality of layers, including up to 20 layers. More preferably, the multilayer sealant includes 6 or less layers. Furthermore, the coextruded multilayer sealant preferably has a thickness of 5-100 μm, more preferably 10-50 μm.

The peelable heat sealable layer is preferably applied on top of the polyester layer via extrusion coating, where a molten curtain of resin is deposited on the film against a chill drum.

The polyester layer used in this invention may include an anti-fogging agent, an antistatic agent, a thermal stabilizer, a nucleating agent, an antioxidant, a lubricant, anti-blocking agents, a mold release agent, an ultraviolet absorbing agent, and/or a coloring agent.

The biaxially oriented polyester layer can include any suitable material. For example, in embodiments, the polyester layer can include high intrinsic viscosity (IV) homopolyesters or copolyester of PET/PBT, for example, in embodiments, an intrinsic viscosity (IV) >0.50 or an IV of >0.60.

In one embodiment, an extrusion coated film is made by coating a film, made of polyester, with a polymeric resin layer. The polyester film's thickness can be, for example, from about 5 microns to about 250 microns, most preferably from about 9 microns to about 50 microns. The polyester film can be uncoated, coated, metalized, or sputtered. It can include a plurality of layers, for example, as many as 20 layers, most preferably 10 layers or less.

The peelable heat sealable layer can be comprised of as many as 20 layers, most preferably as many as 10 layers, most preferably as many as 6 layers. This peelable layer consists of coextruded layers that will function as peelable or break away seal layers. This construction is not limited to extrusion coated film, but it covers coextruded films made by blown or cast process. Such peelable heat seal layer can range in total thickness from 5-100 μm, most preferably from 10 to 50 μm. Each coextruded layer can be of different thickness and different composition. In general terms, the peelable heat sealable layer will comprise polyethylene components with density values in the range of 0.840-0.935 g/cm₃ as, 0.840-0.920 g/cm³ is more preferred.

The peelable heat sealable layer will provide seal strength values between 1-5 lbs/in when sealed to itself at 275° C., 30 psia, 0.5 seconds in a heat sealer unit such as Sentinel 12AS/1 made by Sencorp. The seals should provide separation with no visual delamination or tearing of the seal interface.

The following Examples are being submitted to further define various species of the present disclosure. These Examples are intended to be illustrative only and are not intended to limit the scope of the present disclosure.

### Testing and Examples

Mineral Oil Saturated Hydrocarbons (MOSH) have been detected in the analysis of cereal liners that have been packaged with recycled paperboard boxes. Straight chain hydrocarbons (MOSH) are very migratory. The toxicity of mineral oil (MOSH) is dictated in part by chain length (below C24). Our testing, as detailed below done at PIRA labs in the UK, is based on MOSH migration.

### Test Protocol

6 films and one control cereal bag were tested.

The pouches were sealed, after placing a sample of Tenax TA porous polymer (Poly(2,6-diphenylphenylene oxide)).

Three samples of each variable were tested.

The Tenax was saturated in limonene and Pentadecane hydrocarbon.

The limonene was used as a migratory flavor simulant and the pentadecane was used to simulate a range of oils in newsprint.

Blank Tenax was used as a baseline.

A 10 day time study was used at 60° C. (this replicates about 6 months of real time aging).

Samples were removed and analyzed via Gas Chromatography.

The results in the attached table, are expressed in micrograms of analyte permeating per square decimeter of film.

### EXAMPLE 1

### Toray's 48G PA10—A 48 Gauge Coextruded Polyester Film with a Heat Seal Layer

A biaxially oriented polyester film with a heat seal layer was produced by melt-extruding a polyester resin into a film. A polyester resin was formed by reacting dimethyl terephthalate with ethylene glycol in the presence of a catalyst at a temperature of 302-410° F. (150-210° C.). The resulting chemical, a monomer (single, non-repeating molecule) alcohol, is combined with terephthalic acid and raised to a temperature of 472° F. (280° C.). The molten polyester resin is extruded through a slot and then quenched. This film is then wound onto a casting drum forming an unstretched film. The heat seal layer is added to the film by coextruding a layer of sealable polyester resin onto the polyester core. The biaxially oriented film is formed by stretching the unstretched film one or more times to a total stretching ratio of 3 to 7 times in a longitudinal direction at a temperature of Tg to (Tg+60)° C., stretching the film to a total stretching ratio of 3 to 5 times in a transverse direction at Tg to (Tg+60)° C., heating the biaxially oriented film at (Tg+50) to (Tg+140)° C. for 1 to 100 seconds, and heating it again while it is being shrunk or extended in a transverse direction by 0 to 3%. This film was tested for tested for Limonene and Pentadecane barrier characteristics as shown in Table 1.

### EXAMPLE 2

### Toray's 36G QM51—A 36 Gauge Coextruded Polyester Film Vacuum Metalized with Aluminum

A 36 gauge coextruded polyester film structure including a heat seal layer was made in a similar process as Example 1, but the polyester base film was further converted. The polyester film was metalized in a vacuum chamber at 10-4 mbar to 2.8 optical density. This film was tested for tested for Limonene and Pentadecane barrier characteristics as shown in Table 1.

### EXAMPLE 3

### Toray's 48G PA10—A 48 Gauge Coextruded Polyester Film Extrusion Coated with 1 Mil of Polyolefin Sealant

The base polyester film was made in a similar process as Example 1. The base polyester film was then extrusion coated with a peelable heat sealable layer.

The peelable seal was a separable joint formed by heat sealing. The mechanical resistance of the peelable seal must be low enough to permit ready manual opening of the joint, i.e., without the use of any auxiliary instrument.

The blend used during this test, utilized about 50 percent by weight of a polyolefin based plastomer or elastomer and about 50 percent by weight of a second plastomer or elastomer (of different density and melt index). This produced a peelable seal film, namely in the 1-5 lbs/in range, measured at 275° F., 30 psia, 0.5 seconds dwell. The blend was processed by extrusion coating at melt temperatures between 250-335° C. The total thickness of this seal layer was 1 mil (100 gauge).

The first component in the blends of the present invention is a polyolefin plastomer with density between 0.84 and 0.910 gm/cubic cm based on ASTM D792 and a melt index between 3 and 10 gm/10 min, based on ASTM D1238. This component exhibits vicat softening point in the 40-60 degrees C. range based on ASTM D1525.

The second component in the blends of the present invention is a different polyolefin-based plastomer with density between 0.880 and 0.92 gm/cubic cm based on ASTM D792 and a melt index between 6 and 10 gm/10 min based on ASTM D1238. This second component exhibits a vicat softening point in the 60-90 ° C. range based on ASTM D1525. This film was tested for tested for Limonene and Pentadecane barrier characteristics as shown in Table 1.

### Comparative Example 4

### Toray's 800 CBS—A 80 Gauge Coextruded Oriented Polypropylene with a Heat Seal Layer

Toray's 80G CBS is a coextruded oriented polypropylene film including an ethylene containing heat seal layer. This film was tested for tested for Limonene and Pentadecane barrier characteristics as shown in Table 1.

### Comparative Example 5

### Toray's 700 PWX5—A 70 Gauge Coextruded Oriented Polypropylene Film In-Line Coated with a High Barrier Coating and Then Vacuum Metalized with Aluminum

Toray's 70G PWX5 is a 70 gauge coextruded oriented polypropylene film in-line coated with a high barrier coating and vacuum metalized with aluminum. The film was manufactured in a similar process as the film in Example 3, except that the polypropylene film was metalized in a vacuum chamber at 10-4 mbar to 2.4 optical density. This film was tested for tested for Limonene and Pentadecane barrier characteristics as shown in Table 1.

### Comparative Example 6

### Toray's 700 PMX—A 70 Gauge Coextruded Oriented Polypropylene with a Heat Seal Layer That Has Been Vacuum Metalized with Aluminum

Toray's 70G PMX is a 70 gauge coextruded oriented polypropylene with a heat seal layer that has been vacuum metalized with aluminum. The film is manufactured in a similar process as the film in Example 3, except that the polypropylene film was metalized in a vacuum chamber at 10-4 mbar to 2.0 optical density. This film was tested for tested for Limonene and Pentadecane barrier characteristics as shown in Table 1.

### Comparative Example 7

### 215G Control—A 215 Gauge Blown High Density Polyethylene Film with a Heat Sealable Layer

215G is a 215 gauge blown high density polyethylene film with a heat sealable layer. The polyethyelene film is made from high density polyethylene (HDPE) with a density of 0.941 gm/cm³. This film was tested for tested for Limonene and Pentadecane barrier characteristics as shown in Table 1.

TABLE 1
Summary of Examples

| | Limonene | Pentadecane |
|---|---|---|
| Film Type | μg/dm2 | μg/dm2 |
| 48 ga PET (PA10) | 0 | 0 |
| 36 ga QM51 (MET PET) | 0 | 0 |
| 48 ga PET (PA10) with 1 mil | 0 | 0 |
| peelable sealant | | |
| 80 ga OPP (CBS) | 17,266 | 7,378 |
| 70 ga MET OPP (PWX5) | 432 | 428 |
| 70 ga MET OPP (PMX) | 2,110 | 443 |
| 215 g HDPE/Ionomer (control | 12,523 | 9,070 |
| Cereal bag) | | |

The results show that the cereal bags made with the polyester base films, show zero limonene and zero pentadecane migration.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A barrier film comprising:
a base film layer comprising polyester; and
an extrusion coated peelable heat seal layer comprising polyethylene, wherein the barrier film has a thickness of 5 microns to 250 microns.

2. The barrier film of claim 1, wherein the barrier film has a thickness of 9 microns to 50 microns.

3. The barrier film of claim 1, wherein base film layer comprises 1 to 20 coextruded layers.

4. The barrier film of claim 1, wherein the barrier film further comprises a metalized layer, or a colored layer.

5. The barrier film of claim 1, wherein the peelable heat seal layer comprises 1 to 20 layers.

6. The barrier film of claim 1, further comprising an outer surface printable layer.

7. The barrier film of claim 1, wherein the heat seal layer comprises polyethylene with a density of 0.840-0.935 g/cm³.

8. The barrier film of claim 1, wherein the heat seal layer comprises polyethylene with Melt Flow Rate of 0.1-10 g/10 minutes.

9. The barrier film of claim 1, wherein the base film layer is biaxally oriented.

10. The barrier film of claim 1, wherein the base film contains at least 90 wt. % polyester.

11. The barrier film of claim 1, wherein the heat seal layer contains at least 75 wt. % polyethylene.

12. The barrier film of claim 1, wherein the base film layer comprises polyester with an intrinsic viscosity (V) of greater than 0.50.

13. A cereal liner formed from a barrier film, the barrier film comprising:
a base film layer comprising polyester; and
an extrusion coated peelable heat seal layer comprising polyethylene,
wherein the barrier film has a thickness of 5 microns to 250 microns.

14. The cereal liner of claim 13, wherein the barrier film further comprises a metalized layer, or a colored layer.

15. The cereal liner of claim 13, further comprising an outer surface printable layer.

16. The cereal liner of claim 13, wherein the heat seal layer comprises polyethylene with a density of 0.840-0.935 g/cm³.

17. The cereal liner of claim 13, wherein the heat seal layer comprises polyethylene with Melt Flow Rate of 0.1-10 g/10 minutes.

18. The cereal liner of claim 13, wherein the base film layer is biaxally oriented.

19. The cereal liner of claim 13, wherein the base film contains at least 90 wt. % polyester.

20. The cereal liner of claim 13, wherein the heat seal layer contains at least 75 wt. % polyethylene.

21. The cereal liner of claim 1, wherein the base film layer comprises polyester with an intrinsic viscosity (V) of greater than 0.50.

22. A method of making a barrier film comprising:
providing a base film layer comprising polyester; and
extrusion coating a peelable heat seal layer comprising polyethylene onto the base film layer, wherein the barrier film has a thickness of 5 microns to 250 microns.

23. The method of claim 22, wherein base film layer comprises 1 to 20 coextruded layers.

24. The method of claim 22, further comprising applying a metalized layer, or a colored layer onto the base film layer.

25. The method of claim 22, wherein the peelable heat seal layer comprises 1 to 20 layers.

26. The method of claim 22, further applying an outer surface printable layer onto the base film layer.

27. The method of claim 22, wherein the heat seal layer comprises polyethylene with a density of 0.840-0.935 g/cm³.

28. The method of claim 22, wherein the heat seal layer comprises polyethylene with Melt Flow Rate of 0.1-1000 minutes.

29. The method of claim 22, further comprising biaxally orienting the base film layer.

30. The method of claim 22, wherein the base film contains at least 90 wt. % polyester.

31. The method of claim 22, wherein the heat seal layer contains at least 75 wt. % polyethylene.

32. The method of claim 22, wherein the base film layer comprises polyester with an intrinsic viscosity (V) of greater than 0.50.
